(19) United States
(12) Patent Application Publication
(10) Pub. No.: US 2005/0276469 A1
(43) Pub. Date: Dec. 15, 2005

(54) Method for detecting face region using neural network

(76) Inventor: Yong Sung Kim, Seoul (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/514,527

(22) PCT Filed: May 20, 2002
(86) PCT No.: PCT/KR02/00951

§ 371 Date: May 6, 2005

(51) Int. Cl. G06K 9/62

(52) U.S. Cl. 382/159

(57) ABSTRACT

A method for detecting a face region using a neural network includes a) producing a skin color mask which shows if a pixel value of an input image is close to the skin color, b) determining if a face region exists by making only the pixel which has a color close to the skin color pass through the neural network while skipping an image having a predetermined size per pixel vertically and horizontally, and c) determining if a face region exists by making pixels surrounding the pixel determined as the face region in the step b) pass through the neural network Thus, the face region can be detected at high speed.

### TECHNICAL FIELD

The present invention relates to development of multimedia service systems, and more particularly, to a method for detecting a face region by using a neural network, in which the face region of a person is detected from a still or moving picture at a high speed by using the neural network.

### BACKGROUND ART

Recently, as use of digital video increases rapidly, starting from video search by means of video indexing, development of a variety of multimedia service systems has been made. In this instance, a face of a person in a video may be used as very important element in indexing the video.

Accordingly, automatic detection of a region having the face of the person from the still or moving picture is required for employing a system for indexing a video or a system for sensing a face by using the face of a person in a video.

Recently, H. A. Rowley, S. Baluja, and T. Kanade write a paper on a method for detecting a face region by using a neural network titled, “Neural Network-Based Face Detection”, IEEE Trans. on Pattern Analysis and Machine Intelligence, Vol. 20, No. 1, January 1998.

In general, the neural network is circuit having a rule stored therein for providing a fixed output for a fixed input. An input data provides different values depending on a weighted value in the neural network, which weighted value is adjusted to provide a fixed output for an input prepared in advance. A process for adjusting the weighted value in the neural network to provide the fixed output for the input data prepared in advance is called as giving a lesson to the neural network. The neural network is generalized such that, once a lesson is given by using numerous input-output data pairs, the neural network can derive an appropriate output, not only for a particular input-output pair, but also for an input similar thereto.

FIG. 1 illustrates a flow chart showing the steps of a related art method for detecting a face region by using a neural network disclosed by H. A. Rowley et al., and FIG. 2 describes searching of a 20×20 image size by using a related art method for detecting a face region by using a neural network.

At first, a neural network to be used for detection of a face region is initialized (101S). The neural network is given a lesson such that the neural network receives a 20×20 sized image, and provides “FACE” if there is a face in the image, and “NONFACE” if there is no face.

If an image intended to detect a face region therefrom is received, the image is searched for a 20×20 sized face by using the neural network (102S˜105S).

The searching method will be described in detail. After all values in a Result, a memory space for storing a result passed through the neural network, are initialized to NULL (102S), the image is cut into 20×20 sized windows, and provided to the neural network starting from a left upper window, results of the provision to the neural network are stored in corresponding positions of the Result, and this process is repeated until search of an entire ‘n×m’ sized image is finished by shiffing the pixels one by one (103S). That is, a result of the providing a 20×20 sized image to the neural network starting from a point (x, y) on the image to a point (X+19, Y+19) is provided to (x, y). A result of providing a 20×20 sized image to the neural network starting from a point (x+1, y), moving to a right side by one pixel, to a point (x+20, y+19) is provided to (x+1, y). Thus, a result of providing a 20×20 sized image to the neural network starting from a right most point (x+n−19, y), keep moving to the right side by one pixel, to a point (x+n, y+19) is provided to (x+n−19, y). Also, a result of providing a 20×20 sized image to the neural network starting from a point (x, y+1), moving to a lower side by one pixel, to a point (x+19, y+20) is provided to (x, y+1).

Finish of search of entire picture is determined by repeating the foregoing process, to progress searching entire picture, and if the search of entire picture is finished, a detected face region is stored (106S).

That is, if there is a face in a range of 20×20 size is present in a certain region of the image, according to the generalizing characteristic of the neural network, the neural network provide “FACE” for a few pixels adjacent to the region. Accordingly, if “FACE”s are displayed for pixels equal to, or greater than a number ‘K’ when the Result the results passed through the neural network are stored therein is retrieved, it is regarded that there is a face at the position, the position is put on a list. However, even though “FACE”s are displayed for adjacent one or two pixels, if a number of the pixels are not greater than a threshold value ‘K’, regarding that the “FACE”s are displayed owing to misunderstanding of the neural network rather than presence of a face in the part actually, the display of the “FACE”s are disregarded. Though it may be dependent on a level of the lesson given to the neural network, the threshold value ‘K’ in a range of 3˜6 is appropriate.

In this instance, there can be a case when detection of the face region fails even if the foregoing process is repeated in a case a size of the face is larger than 20×20 (40×40). Therefore, it is determined whether a size of a picture to be searched is larger than a minimum image size (a case equal to, or smaller than 20×20 ) or not (107S), if it is determined that the size of the picture is not the minimum image size, the image is reduced little by little until the size of the image becomes the minimum image size, and the foregoing process is repeated for every reduced size image (108S).

When the search for all sizes of image is finished, existence of overlapped regions out of detected regions up to now is verified, and, if there are the overlapped regions, after the overlapped regions are put together, a result of the face region detection is provided (109S).

### DISCLOSURE OF INVENTION

However, the related art method for detecting a face region by using a neural network has the following problems.

The face region detection performance of the related art method for detecting a face region by using a neural network is dependent on a performance of the neural network, and, though the neural network can detect the face region very accurately if the neural network has been given lessons properly with a large amount of data, because the method requires to reduce the image little by little, and to search every pixel in entire region of every one of the reduced images, the method requires a large amount of calculation, and takes a long time. That is, it is verified that processing of one sheet of image with 320×320 pixels requires 383 seconds at 200 MHz R440 SGI Indigo 2 workstation.

An object of the present invention, designed to solve the foregoing problem, lies on providing a method for detecting a face region by using a neural network, in which an amount of calculation in a step of searching a face region by using the neural network the largest amount of calculation is concentrated thereon is reduced for improving a speed of the calculation while a performance of the algorithm is not sacrificed.

The object of the present invention can be achieved by providing a method for detecting a face region using a neural network including a first step for generating a skin color mask indicating whether a pixel value of a received image is a skin color or not, a second step for dividing a picture into predetermined sized images, and passing only pixels of skin colors through the neural network while every other pixel is skipped in horizontal and vertical directions for determining whether the pixel is a face region or not, and a third step for passing peripheral pixels of the pixel determined to be the face region in the second step through the neural network to determine whether the peripheral regions are the face regions or not.

### BRIEF DESCRIPTION OF THE DRAWINGS

The accompanying drawings, which are included to provide a further understanding of the invention, illustrate embodiment(s) of the invention and together with the description serve to explain the principle of the invention. In the drawings;

FIG. 1 illustrates a flow chart showing the steps of a related art method for detecting a face region by using a neural network;

FIG. 2 illustrates a diagram of an order of search for describing a related art method for detecting a face region by using a neural network;

FIG. 3 illustrates a flow chart showing the steps of a method for detecting a face region by using a neural network in accordance with a preferred embodiment of the present invention;

FIG. 4 illustrates a diagram of a search sequence for a primary loop of the present invention; and

FIG. 5 illustrates a diagram of a search sequence for a secondary loop of the present invention.

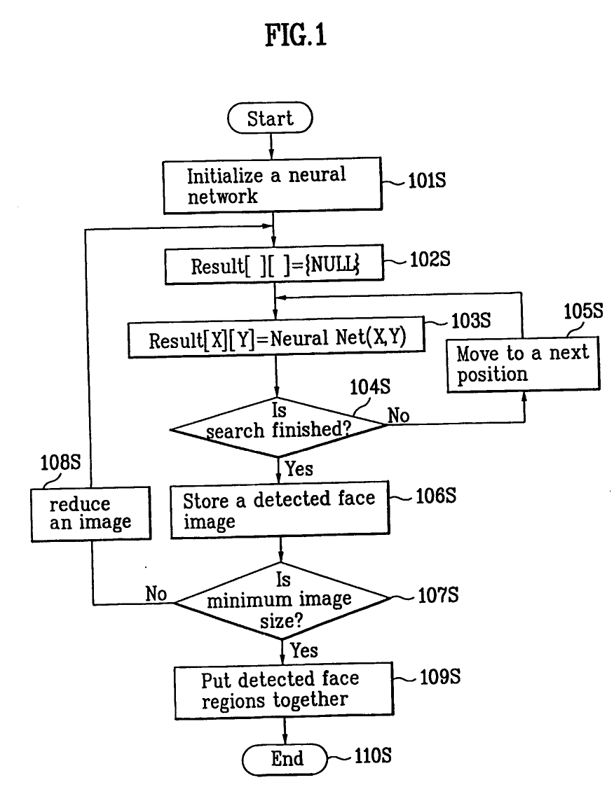

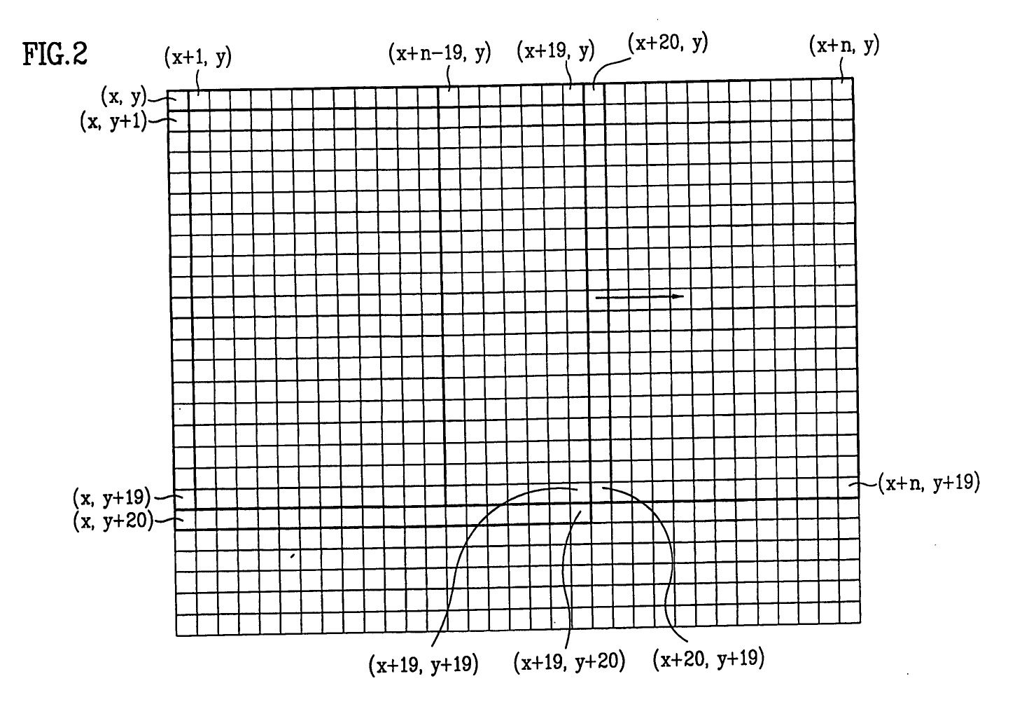

### BEST MODE FOR CARRYING OUT THE INVENTION

Reference will now be made in detail to the preferred embodiments of the present invention, examples of which are illustrated in the accompanying drawings. In describing the embodiments of the present invention, same parts will be given the same names and reference symbols, and repetitive description of which will be omitted.

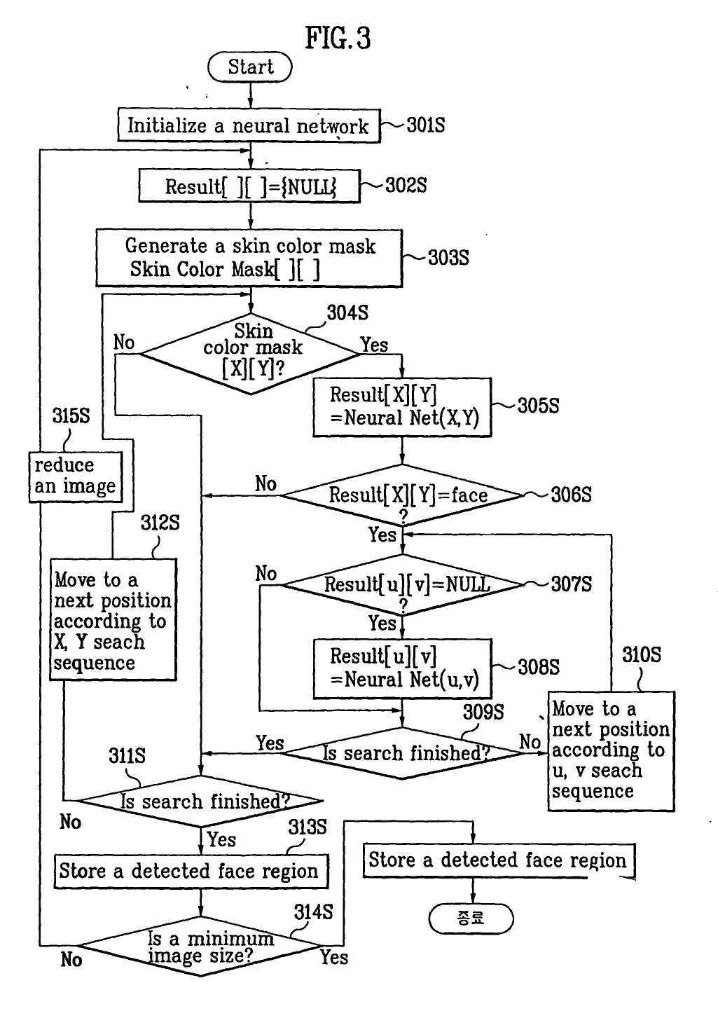

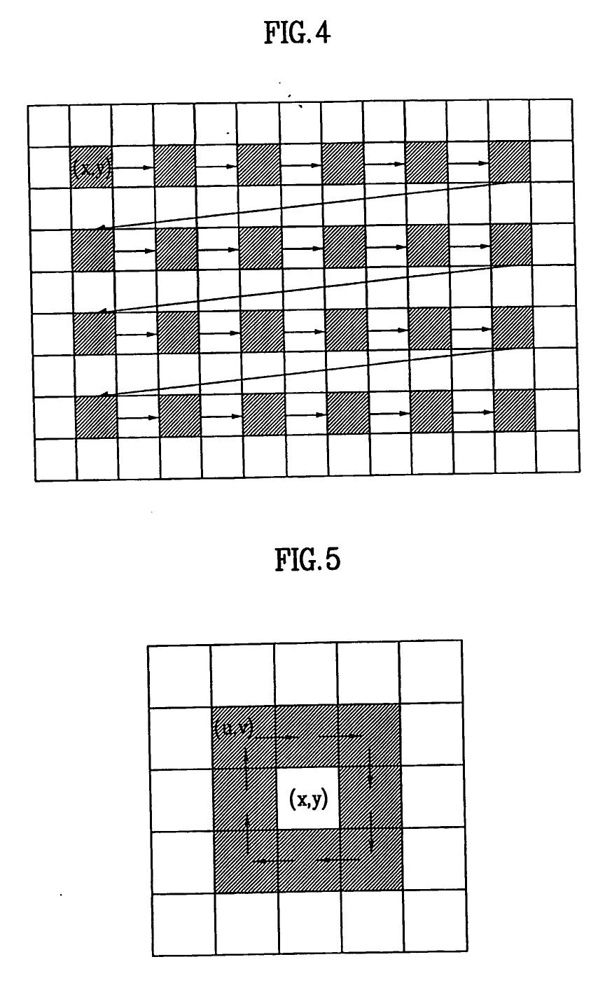

FIG. 3 illustrates a flow chart showing the steps of a method for detecting a face region by using a neural network in accordance with a preferred embodiment of the present invention, FIG. 4 illustrates a diagram of a search sequence for a primary loop of the present invention, and FIG. 5 illustrates a diagram of a search sequence for a secondary loop of the present invention.

Referring to FIG. 3, the method for detecting a face region by using a neural network in accordance with a preferred embodiment of the present invention includes a primary loop having the steps of 304S, 305S, 311S, and 312S, and a secondary loop having the steps of 307S, 308S, 309S, and 310S.

In the primary loop, a process is repeated in which an objective image is provided to the neural network in 20×20 sized images starting from a left upper part, and a result of the provision is stored at a relevant position while skipping every other pixel in a horizontal direction or a vertical direction.

In the secondary loop, if a face region is detected in the process of the primary loop, a periphery of the detected region is searched, and a result of the search is stored at a relevant position.

At first, alike the related art, the neural network is initialized (301S), and all values in a Result, a memory space for storing results passed through the neural network, is initialized to NULL (302S).

Then, a skin color mask, a memory space having a size the same with an input image, is generated (303S and 304S), a pixel value at a (x, y) position in the input image is checked, “TRUE” is stored at (x, y) position of the skin color mask if the pixel value is one of skin colors, and “FALSE” is stored at (x, y) position of the skin color mask if the pixel value is not one of skin colors (305S). In this instance, the question of what colors can be regarded as the skin colors can differ applications, and methods for determining the skin colors are disclosed on many papers, such as “Statistical Color Models with Applications to Skin Detection,” Technical Report 98-11, Compaq Cambridge Research Laboratory, December, 1998, disclosed by M. J. Jones and J. M. Rehg, and “A Real Time Face Tracker,” Workshop on Applied Computer Vision, pp 142-147, Sarasota, Fla., 1996, disclosed by J. Yang, and A Waibel.

Naturally, as a face has a skin color, the amount of calculation can be reduced significantly by omitting the step of verifying the cases when the skin color mask is FALSE represent the face region or not. However, depending on applications, there are necessities for abstracting the face regions from regions which have no skin colors, when values of all the color mask are set to “TRUE” according to request from the user, for detecting the face region for entire region without taking the step of verifying skin color.

If no face region is detected from the primary loop (306S), different from the related art, the search is progressed while skipping every other pixel in horizontal and vertical directions according to the search sequence (312S). That is, as shown in FIG. 4, a 20×20 sized image starting from a left upper end (x, y) to a point (x+19, y+19) is provided to the neural network, and a result of which is stored in (x, y) position. Then, skipping objective images by one pixel, a 20×20 sized image starting from a point (x+2, y) to a point (x+21, y+19) is provided to the neural network, and a result of which is stored in (x+2, y) position. According to this method, by skipping every other pixel in the horizontal and vertical directions, 20×20 sized images are processed.

In the middle of above process, if a processed 20×20 sized image is determined to be a face region ‘FACE’ (306S), a peripheral region of the 20×20 sized image is searched. That is, as shown in FIG. 5, if it is assumed that a 20×20 sized image is determined to be the face region, and a result of which is stored at (x, y) position of which periphery position is (u, v), a memory space for storing results of 20×20 sized images in the peripheral region is initialized (307S), a 20×20 sized image starting from a point (u, v) to a point (u+19, v+19) is provided to the neural network, and a result of which is stored at (u, v) (308S). According to a (u, v) search sequence, the process proceeds to the next position. That is, a 20×20 sized image starting from a point (u+1, v) to a point (u+20, v+19) is provided to the neural network, and a result of which is stored at (u+1, v). Then, a 20×20 sized image starting from a point (u+2, v) to a point (u+21, v+19) is provided to the neural network, and a result of which is stored at a (u+2, v) position, and, then, a 20×20 sized image starting from a point (u+2, v+1) to a point (u+21, v+20) is provided to the neural network, and a result of which is stored at a (u+2, v+1) position. Next, a 20×20 sized image starting from a point (u+2, v) to a point (u+21, v+19) is provided to the neural network, and a result of which is stored at a (u+2, v) position. Thus, the peripheral region of a face region is searched by repeating above process, and results of which are stored at relevant positions. In this instance, the 20×20 sized image starting from a (u, v) position of the image is provided to the neural network only when a starting 20×20 sized window is a window that not is provided to the neural network yet, for preventing unnecessary duplication of search.

The foregoing process is repeated until search of entire picture is finished, and the finish of entire picture is determined, and if it is determined that the search of entire picture is finished (311S), detected face regions are stored (313S).

Alikely, in this invention too, upon checking the Result results passed through the neural network are stored therein, if the ‘FACE's are displayed for more than ‘K’ adjacent pixels, regarding that there is a face at the position, the position is stored on a list. However, even if the ‘FACE's are displayed for one or two pixels, if the number fails to exceed the threshold value, regarding that the ‘FACE's are displayed owing to misunderstanding of the neural network, rather than presence of a face in the part actually, the ‘FACE’ displays are disregarded.

There can be a case when detection of the face region fails even if the foregoing process is repeated, if a face size is larger than 20×20 size (40×40). Therefore, it is determined whether a size of a picture to be searched is a minimum image size (a case equal to, or smaller than 20×20 ) or not (314S), if it is determined that the size of the picture is not the minimum image size, the image is reduced little by little until the size of the image becomes the minimum image size, and the foregoing process is repeated for every reduced size image (315S).

When the search of face region for all sizes of images is finished, detected face regions are put together, a result of the face region detection is provided (316S).

### INDUSTRIAL APPLICABILITY

As has been described, the method for detecting a face region by using a neural network has the following advantages.

First, the search of only parts having a high possibility of a face with skin color masks by using a neural network permits to reduce an amount of calculation as much as images having much non-skin colors.

Second, even in a case entire picture has skin colors, by dividing a step of searching the picture into two steps, in which a face region is determined while skipping every other pixel of the image, and verification of peripheral pixels of being the face region by using the neural network is omitted for parts that are not the face regions, the search process by using the neural network can be reduced to approx. ¼ without sacrifice of a detecting performance.

There is no deterioration of the detection performance at all even if the detection proceeds while every other pixel is skipped in horizontal and vertical directions, because a region is understood as the face region only when more than ‘K’ adjacent pixels display ‘FACE's upon checking the Result in which results passed through the neural network in a step next to the step for detecting by using the neural network is stored therein, there is no case when a face region required to be detect is missed completely, even if every other pixel is skipped in horizontal and vertical directions.

When all the neural network are carried out in integer operations, one sheet of 320×240 pixel image can be processed within average 0.5 seconds at 600 MHz Pentium III PC.

1. A method for detecting a face region using a neural network comprising:
a first step for generating a skin color mask indicating whether a pixel value of a received image is a skin color or not;
a second step for dividing a picture into predetermined sized images, and passing only pixels of skin colors through the neural network while every other pixel is skipped in horizontal and vertical directions for determining whether the pixel is a face region or not; and
a third step for passing peripheral pixels of the pixel determined to be the face region in the second step through the neural network to determine whether the peripheral regions are the face regions or not.

2. The method as claimed in claim 1, further comprising the steps of repeating the steps while a size of the picture is reduced little by little.

3. The method as claimed in claim 1, further comprising the step of initializing the neural network for receiving a predetermined size of image and determining that whether there is a face or not in the image; and initializing a memory space for storing results from the neural network, before the first step.
